(19) United States
(12) Patent Application Publication
(10) Pub. No.: US 2007/0239901 A1
(43) Pub. Date: Oct. 11, 2007

(54) Multiple mode communication interface for expansion device and PLC host and method for operating the same

(75) Inventor: Hung-Chih Wu, Taoyuan Hsien (TW)

Correspondence Address: HDSL, 4331 STEVENS BATTLE LANE, FAIRFAX, VA, 22033, US

(73) Assignee: Delta Electronics, Inc.

(21) Appl. No.: 11/331,102

(22) Filed: Jan. 13, 2006

(51) Int. Cl. G06F 3/00

(52) U.S. Cl. 710/2

(57) ABSTRACT

A multiple mode communication interface for expansion device and PLC host and method for operating the same. The expansion device includes a microprocessor, a memory unit and a communication interface. The communication interface includes a function setting connection module with multiple function setting to connect the host or the expansiondevice of previous stage or next stage and is used for setting required I/O connection number. In initialization stage, the host determines the type and capacity of the expansion device by a judgment module of the communication interface, and sends a code to the expansion device. The expansion device allows or blocks the data sent from the host and accesses the data stored in the memory unit.

### BACKGROUND OF THE INVENTION

1. Field of the Invention

The present invention relates to a multiple mode communication interface for expansion device and PLC host and method for the same, especially to a multiple mode communication interface for generic or special expansion device and PLC host, wherein the serial digital number expansion, the serial and parallel expansion modes of special expansion devices can be achieved by a connection module of a communication interface and method for the same.

2. Description of Prior Art

The programmable logic-controfler (PLC) is generally connected to external equipments or devices through the external I/O terminals thereof and controls the external equipments or devices by editing a program thereof. However, the prior art PLC has external I/O terminals with predetermined pin counts and expansion device is need to expand analog or digital pin counts when the prior art PLC is to be connected to more external equipments or devices.

FIG. 1 shows a prior art communication interface for PLC host and expansion device. The communication interface uses 74 series logic circuits 11, 12, 13, and 14 to form a controlled circuit 1. The controlled circuit conveys signals between the host and previous-stage expansion device (or next-stage expansion device) through connection points C1 to C6. The controlled circuit 1 is also connected to input unit 15 and output unit 16 to form a communication connection circuit.

The connection points C1 to C6 includes connection point C1 as an input data connection point and used as X input signal for expansion device and for sending next-stage X input signal to host; connection point C2 as clock transmission point and sending clock signal from host to expansion devices; connection point C3 as an output data connection point and used as Y output signal for expansion device and for sending Y output signal by CPU; connection point C4 as a P/S & STROBE connection point and used as a trigger signal for changing serial/parallel connection of the I/O devices of the expansion devices; connection point C5 as an output enable signal and being normal high after initialization; and connection point C6 as control sign signal and being normal high after initialization.

In the logic circuits 11, 12, 13, and 14, the first logic circuit 11 performs pulse judgment and receives signal input form the connection points C2 and C6 for controlling the timing signal of the host to the I/O units of the expansion device based on the level of the control signal input to the connection point C6. The second logic circuit 12 performs judgment for the Y output signal, which uses the signals of the connection points C3 and C6 and the output data C3+Nt of the output unit 16 and controls the output data of the expansion device to send to the fourth logic circuit 14 and next-stage expansion device based on the level of the control signal input to the connection point C6.

The third logic circuit 13 performs X input signal judgment and uses the connection point C6, the m X input signal Xm, while the Xm sends signal C6·C3+nT +C6·C3 from the host or previous-stage expansion device when C6=1. The third logic circuit 13 controls the X input signal to send to the host or previous-stage expansion device based on the level of the control sign signal input from the connection point C6. The fourth logic circuit 14 performs next stage connection judgment to determine the connection status of next-stage expansion device. The fourth logic circuit 14 sends the signal of the connection points C2 to C6 to next-stage expansion device. The X input signal of next-stage expansion device is sent to the third logic circuit 13 of the previous-stage expansion device through the fourth logic circuit 14.

Moreover, when the above-mentioned PLC host is connected to expansion device, an initialization of the controlled circuit is determined through the expansion device to ensure the normal connection between the host and the expansion device. The controlled circuit is designed by different I/O expansion points and hardware match should be considered. A long pulse signal is necessary. Therefore, the design time is long. When the expansion device is used for multi-segment display and scan matrix of keyboard, I/O point simulation is performed for expansion device hardware and corresponding program is designed for host software. In other word, hardware designs are needed in both host end and expansion device end, which is unduly time consuming.

### SUMMARY OF THE INVENTION

According to one aspect of the present invention, the multiple mode communication interface for expansion device and PLC host is implemented by integrated circuit. The multiple mode communication interface is already defined with different expansion device types and connection module of various function settings. The multiple mode communication interface is used with host for connect the host with various expansion devices. Therefore, the various expansion devices can be flexibly connected and the number of I/O expansion number can be set according to point numbers. The overhead in hardware communication and hardware design for I/O point expansion can be saved.

According to another aspect of the present invention, at least memory unit is provided in the expansion device, and the memory unit is used with the communication interface to form register path for bi-directional data exchange. Therefore the host can be communicated with expansion device in special way such as parallel master-slave mode for non-digital expansion devices.

Accordingly, the present invention provides a multiple mode communication interface for expansion device and PLC host. The multiple mode communication interface comprising
a host comprising
   a communication interface comprising an integrated circuit and a connection module with a plurality of function settings;
   a microprocessor electrically connected to the communication interface;
at least one expansion device comprising:
   a microprocessor;
   a memory unit electrically connected to the microprocessor;
   a communication interface connected to the host and comprising an integrated circuit and further comprising:
   a previous-stage connection module electrically connected to the host or the previous-stage expansion device;
   a next-stage connection module electrically connected to the next-stage expansion device;
   a first setting connection module and a second setting connection module, which setting I/O point expansion and external connection and performing data read and output;
   a hardware mode setting connection module for setting type of the expansion device such that the host can judge in initialization, the hardware mode setting connection module electrically connected to the host or the previous-stage expansion device to send a positioning value or a converted positioning value to next-stage expansion device, whereby the host determines connection status or accessing data through the memory unit by the positioning value;
   a slave mode connection module electrically connected a light emitting element to output digital point status, or the expansion device accessing the data in the memory unit;
   an input control circuit controlling the data reading of the first setting connection module and the second setting connection module;
   an output control circuit controlling the data output of the first setting connection module and the second setting connection module;
   a convert control enable signal (SH) is connected to the host 2 in single wire way,
   a counter electrically connected to the hardware mode setting connection module for generating a counting signal;
wherein the communication interface of the expansion device is connected to the host or the next expansion device, the connection module in the communication interface of the expansion device sets I/O expansion pin to allow the host for connecting to the expansion device, the expansion device automatically allow or block the data from the host and access data stored in the memory unit according to a positioning value output from the host.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a prior art communication interface for PLC host and expansion device.

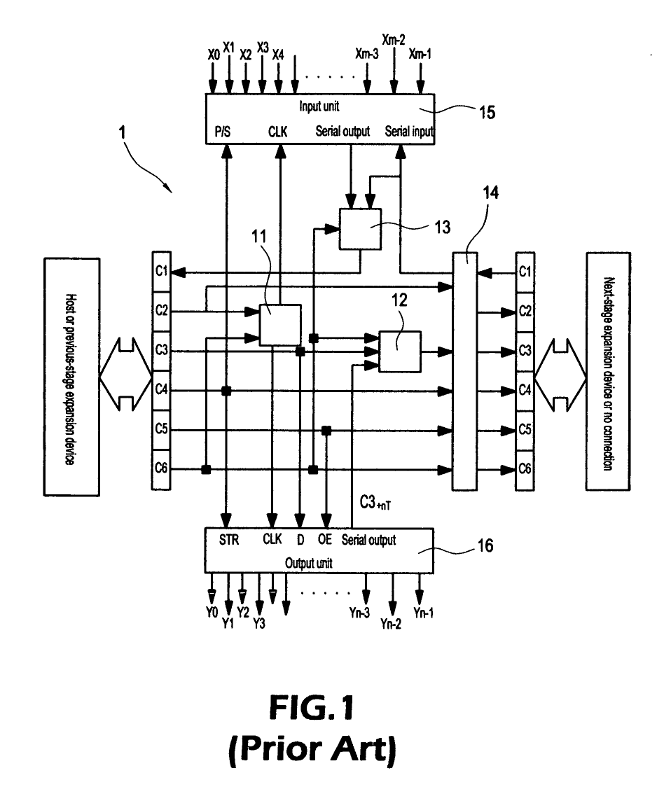

FIG. 2 shows a block diagram of the present invention.

FIG. 3 shows a circuit diagram of the integrated circuit in the communication interface of the present invention.

FIG. 4 shows a block diagram of the input control circuit of the communication interface of the present invention.

FIG. 5 shows a block diagram of the output control circuit of the communication interface of the present invention.

FIG. 6 shows a block diagram of the data input/output for the communication interface of the present invention in serial digital point expansion mode.

FIG. 7 shows a block diagram of the data input/output for the communication interface of the present invention in serial special expansion mode.

FIG. 8 shows a circuit diagram of the communication interface of the present invention in serial special expansion mode.

FIG. 9 is a reading flowchart of the communication interface of the present invention in serial special expansion mode.

FIG. 10 is a writing flowchart of the communication interface of the present invention in serial special expansion mode.

FIG. 11 shows a circuit diagram of the communication interface of the present invention in parallel special expansion mode.

FIG. 12 shows a circuit diagram of the communication interface of the present invention in parallel special expansion mode.

FIG. 13 shows a chip addressing flowchart for the communication interface of the present invention in serial special expansion mode.

FIG. 14 shows a data accessing flowchart for the communication interface of the present invention in serial special expansion mode.

### DETAILED DESCRIPTION OF THE INVENTION

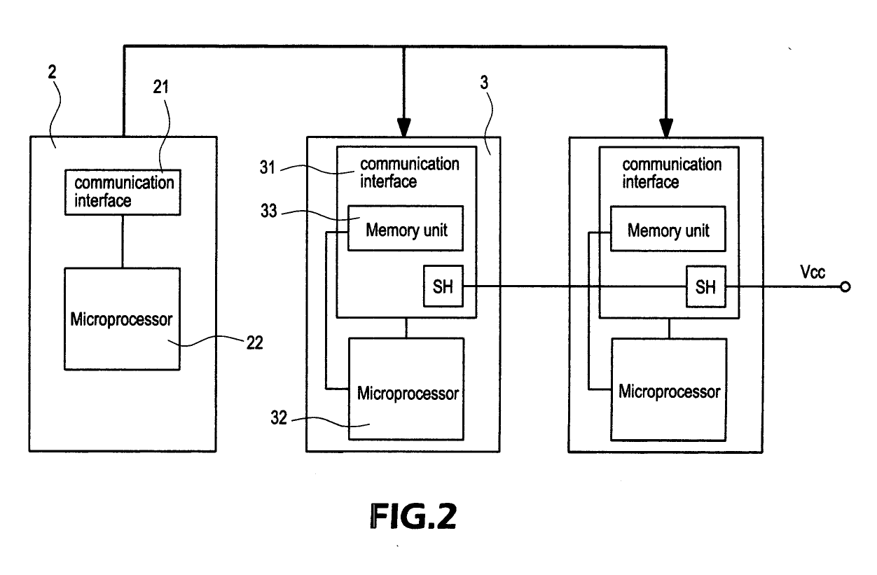

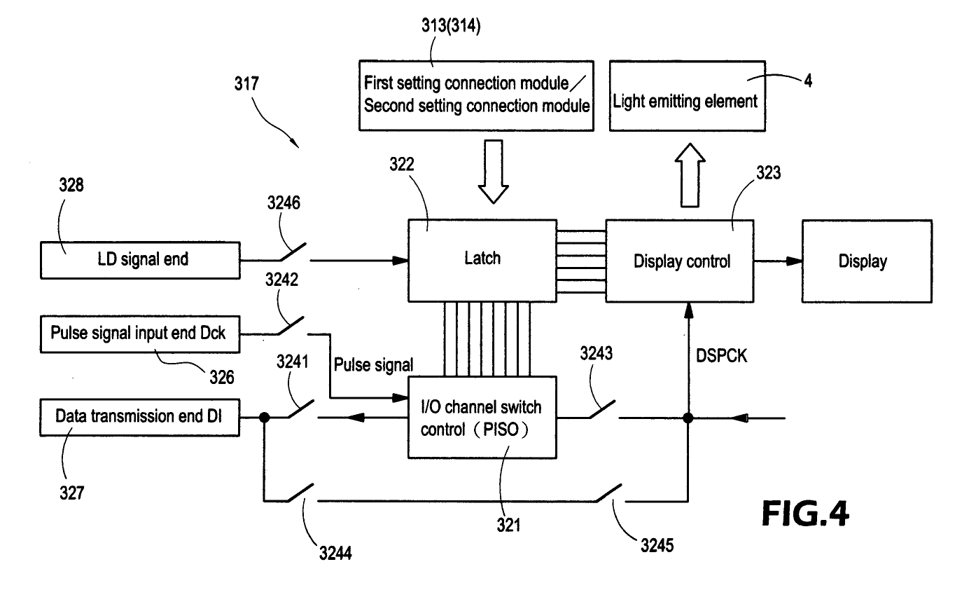

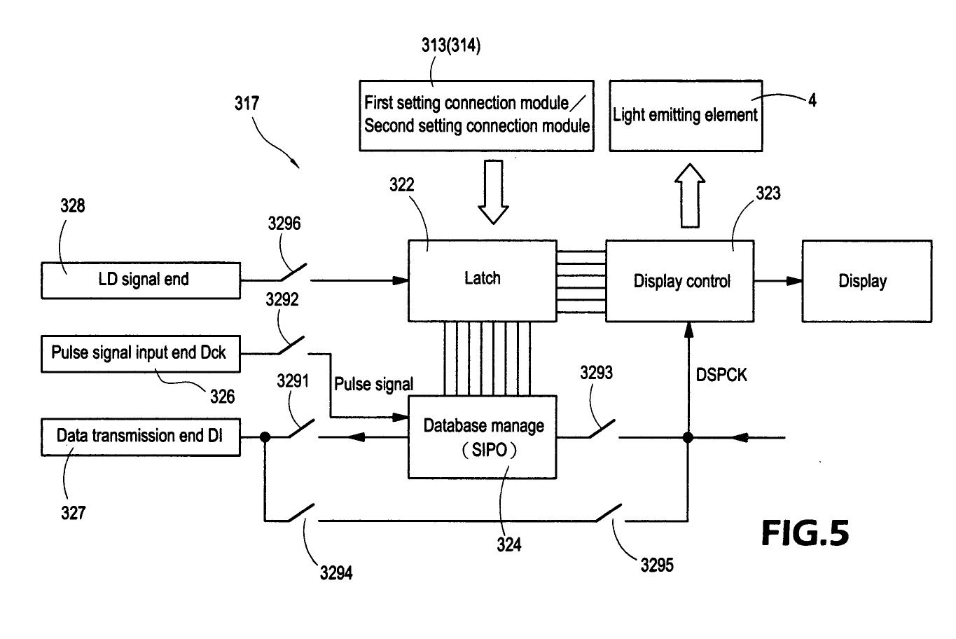

With reference to FIGS. 2 to 5, the multiple mode communication interface for expansion device and PLC host comprises a host 2 and at least one generic or special expansion device 3. The expansion device 3 contains communication interface 31 defining various expansion device types and is connected to the communication interface 21 of the host 2 or the communication interface 31 of previous-stage expansion device 3 or next-stage expansion device 3. Therefore the host 2 can apply various serial or parallel mode connection with the expansion devices and serial or parallel expansion mode connection with the special expansion devices based on the types of the expansion devices. The hardware setting for I/O expansion can be performed through the connection module of the communication interface 31.

The host 2 includes at least a communication interface 21 and a microprocessor 22. The communication interface 21 can be realized by the same IC design as the communication interface 31. The communication interface 21 judges the type and capacity of the expansion device according to hardware setting and outputs code to the expansion device 3 for code and data accessing control.

The expansion device 3 includes a communication interface 31 connected to the host 2 or the previous-stage expansion device 3 or next-stage expansion device 3, and a memory unit 33 connected to the communication interface 31 for bi-directional data accessing of the host 2.

The memory unit 33 is preferably a dual-output design and includes a first output end 331 and a second output end 332.

The communication interface 31 is a hardware-designed IC and defines the types of expansion device and the compatible connection modules.

A previous-stage connection module 311 is connected to the host 2 or the previous-stage expansion device 3 and includes at least one judgment module D_inst0˜2 for identify expansion devices 3 of various types

A next-stage connection module 312 is connected to next-stage expansion device 3, and includes at least one judgment module D_insto0˜2 to identify expansion device 3 of various types.

A first setting connection module (Pb0/AD1_{—}0˜Pb15/AD2_{—}5) 313 and a second setting connection module (Pa0/DATA1_{—}0˜Pa15/RD2n) 314 provides user to set I/O number expansion and external connection for data reading and outputting.

A hardware mode setting connection module (InMode0˜5 & ODEM1˜3) 315 is connected to the host 2 directly or through the expansion device 3 to set the expansion device type for the initialization of the host 2 and the previous-stage expansion device 3. The hardware mode setting connection module 315 fetches the code of the host 2 and the previous-stage expansion device 3 and sends the code to the next-stage expansion device 3. . The hardware mode setting connection module 315 determines whether the host 2 is connectable according to the code or accesses data through the memory unit 33.

A slave mode connection module (LED/DATA2_{—}0˜LED/DATA2_{—}7) 316 is connected to light emitting diode (LED, not shown) to scan and output the status of digital point, or access the host 2 and memory unit 33 through the expansion device 3.

An input control circuit 317 is used for control the data accessing of the first setting connection module (Pb0/AD1_{—}0˜Pb15/AD2_{—}5) 313 and the second setting connection module (Pa0/DATA1_{—}0˜Pa15/RD2n) 314. The input control circuit 317 includes an I/O channel switch control (PISO) 321 and a latch 322 connected to the I/O channel switch control (PISO) 321. A display control 323 is connected to the latch 322 to control the LED 4. The I/O channel switch control (PISO) 321 is connected to pulse signal input end (Dck) 326 and data transmission end (Di) 327 through the switch elements 3241, 3242, and connected to the data input end through the switch element 3243, thus performing signal connection control between the data transmission end (Di) 327 and the data input end through two serially-connected switch elements 3244 and 3245. The latch 322 is connected to LD signal end 328 through the switch element 3246, thus receiving the control signal from the connection module of previous stage. The latch 322 also receives data from the first setting connection module (Pb0/AD1_{—}0˜Pb15/AD2_{—}5) 313 and the second setting connection module (Pa0/DATA1_{—}0˜Pa15/RD2n) 314. An output control circuit 318 is used to control output data from the first setting connection module (Pb0/AD1_{—}0˜Pb15/AD2_{—}5) 313 and the second setting connection module (Pa0/DATA1_{—}0˜Pa15/RD2n) 314. The output control circuit 318 includes a database manage (SIPO) 324 and a latch 325 connected to the database manage (SIPO) 324. A display control 323 is connected to the latch 325 for controlling the operation of the LED 4 to show status of expansion point. The database manage (SIPO) 324 is connected to the pulse signal input end (Dck) 326 and data transmission end (Di) 327 through switch elements 3291 and 3292 and connected to the data input end through the switch element 3293. The database manage (SIPO) 324 performs signal connection control between the data transmission end (Di) 327 and the data input end through the two serially-connected switch elements 3294 and 3295. The latch 322 is connected to LD signal end 328 through switch element 3296 to receive the control signal of the connection module 311 in the previous stage. The latch 322 outputs data from the first setting connection module (Pb0/AD1_{—}0˜Pb15/AD2_{—}5) 313 and the second setting connection module (Pa0/DATA1_{—}0˜Pa15/RD2n) 314.

A counter is connected to the hardware mode setting connection module (InMode0˜5 & ODEM1˜3) 315 for generating counter signal. A convert control enable signal (SH) is connected to the host 2 in single wire way, or the previous-stage expansion device 3 (next-stage expansion device 3) and power source signal Vcc to enhance communication control speed.

In the multiple mode communication interface for expansion device and PLC host according to the present invention, the communication interface 31 of the expansion device 3 and the function setting connection module are defined with various expansion device types and communication connection modes. The expansion device of various types can be connected to the host 2 through the help of the communication interface 31 and the function setting connection modules. For the I/O number expansion, the communication interface 31 and the first setting connection module 313 and the second setting connection module 314 can be used according to requirement. In the initialization of host 2, the communication interface 21 thereof reads signal from one of judgment modules to judge the type and capacity of the expansion device 3. The host 2 sends a code to the expansion device 3 and the expansion device 3 automatically allows or blocks the data sent from the host 2 or accesses the data stored in the memory unit 33 according to the code from communication interface 31 or the code converted from the previous-stage expansion device 3.

The present invention further provides a method for operating multiple mode communication interface for PLC expander and host. The method comprises following steps.

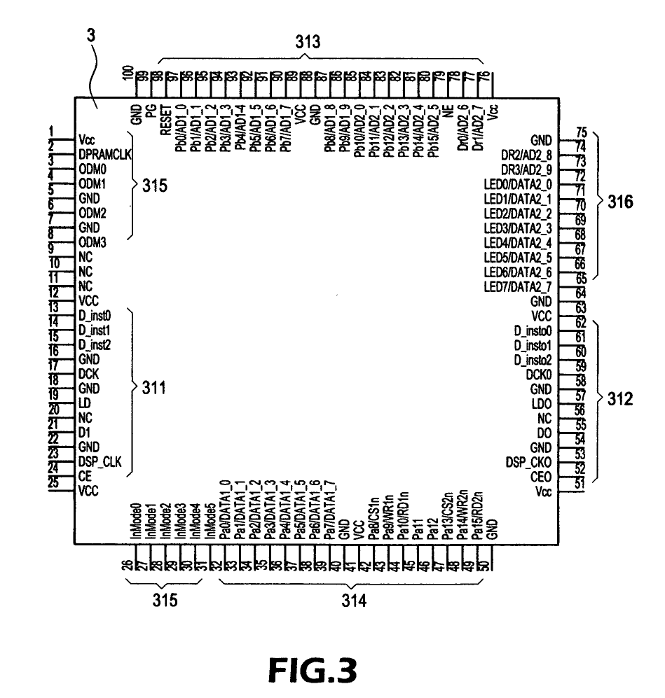

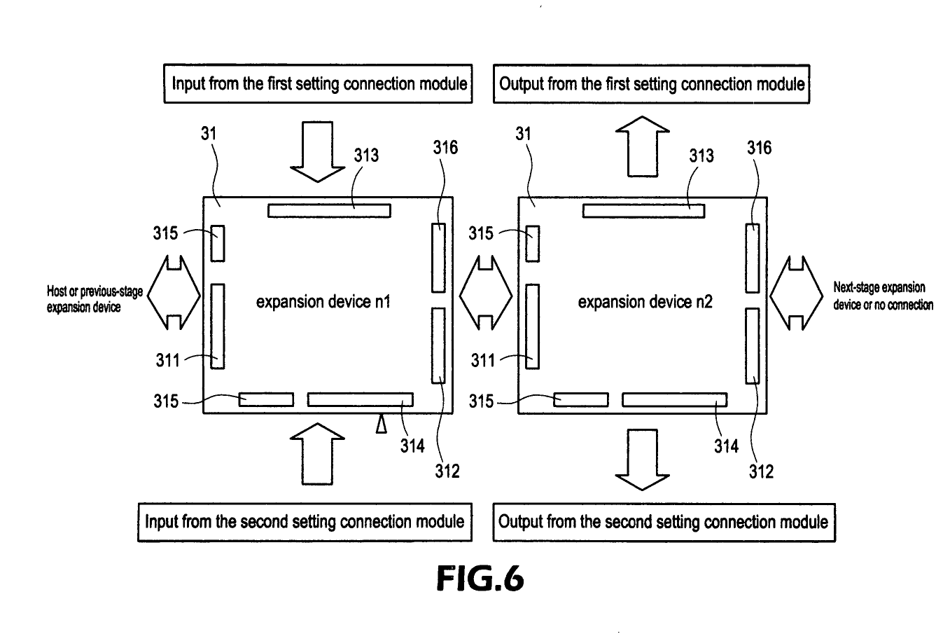

With reference to FIGS. 3 to 6, the serial digital point expansion mode is shown. The expansion device 3 uses the communication interface 31 and the hardware mode setting connection module (InMode0˜5 & ODEM1˜3) 315 to set up the type, code and capacity of the expansion device and the previous-stage connection module 311 and the next-stage connection module 312 are connected to the previous-stage expansion device 3 and the next-stage expansion device 3 to form a serial communication connection between the host 2 and the expansion devices 3. The hardware designer can set up I/O number expansion through the first setting connection module (Pb0/AD1_{—}0˜Pb15/AD2_{—}5) 313 and the second setting connection module (Pa0/DATA1_{—}0˜Pa15/RD2n) 314 of the communication interface 31.

Afterward the host 2 performs an initialization step, where the communication interface 21 reads signal from a judgment module (D_inst0˜2 or D_{—insto}0˜2) to judge the type, code and capacity of the expansion device connected to the host and ensure the normal connection and operation between the host 2 and the expansion devices 3. When a code is sent from the host 2 or the previous-stage expansion device 3, the expansion device 3 will automatically allow or block the data sent from the host 2. When the expansion device 3 judges the code related to allow, the input control circuit 317 and the output control circuit 318 control the data reading and output between the expansion device 3 and the host 2.

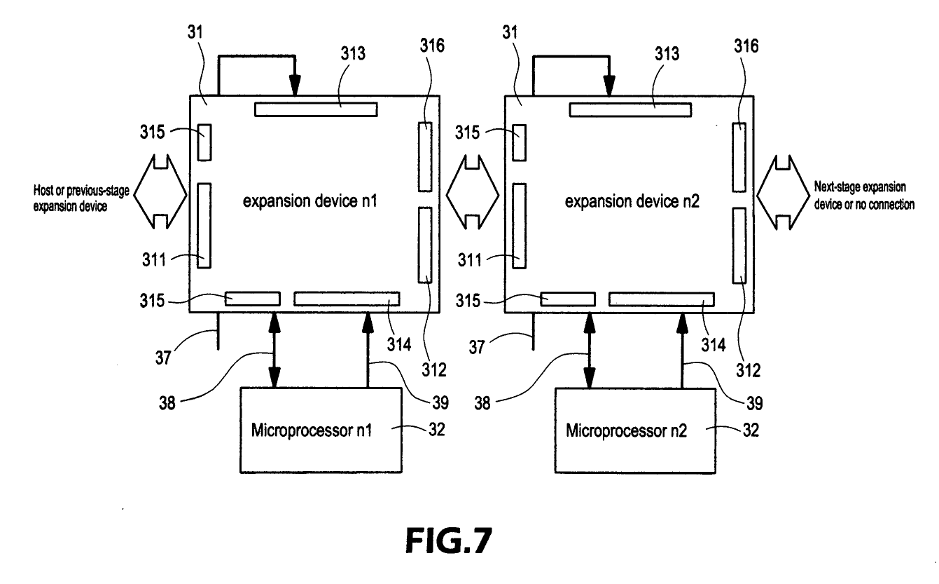

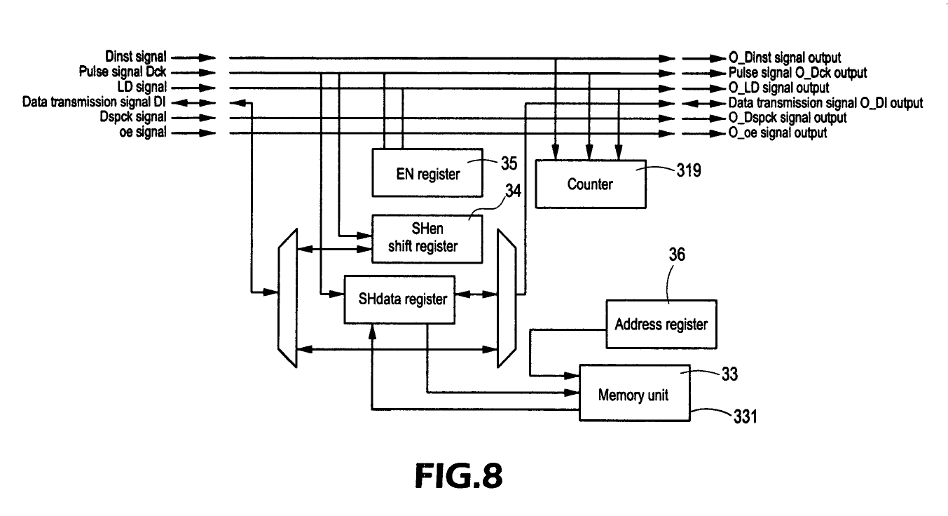

With reference to FIGS. 7 and 8, in the special serial (not digital point) expansion mode (AI/AO mode), the expansion devices 3 uses the communication interface 31 thereof and the hardware mode setting connection module (InMode0˜5 & ODEM1˜3) 315 to set up the type, code and capacity of the expansion device. The previous-stage connection module 311 and the next-stage connection module 312 are connected to the previous-stage expansion device 3 and the next-stage expansion device 3 to form a serial communication connection between the host 2 and the expansion devices 3 through data line 38 and address line 39. The Pb0/AD1_{—}0˜Pb9/AD1_{—}9 connection end in the first setting connection module 313 and the Pa0/DATA1_{—}0˜Pa10/RD1n connection end in second setting connection module314 are used to set the first output end 331 of the memory unit 33 to form an output setting for host mode.

Afterward the host 2 performs an initialization step where the Dinst signal of the host 2 or the previous-stage expansion device 3 is 0. The counter 319 in the expansion device 3 is cleared to zero and signal from a judgment module ( D_inst0˜2 or D_insto0˜2) is read to judge the type, code and capacity of the expansion device connected to the host and ensure the normal connection and operation between the host 2 and the expansion devices 3.

The expansion device 3 receives the code from the host 2 and the previous-stage expansion device 3 through the communication interface 31 and automatically judge to allow or block the data accessing with the host 2. When the judgment is to allow the expansion device 3 to connect between the memory unit 33 and the host 2, a bi-directional data exchange path is formed for data reading and writing. In other word, the memory unit 33 provides a data register and the host 2 uses the serial communication interface 21 to access the temporary data in the memory unit 33 and the expansion device 3.

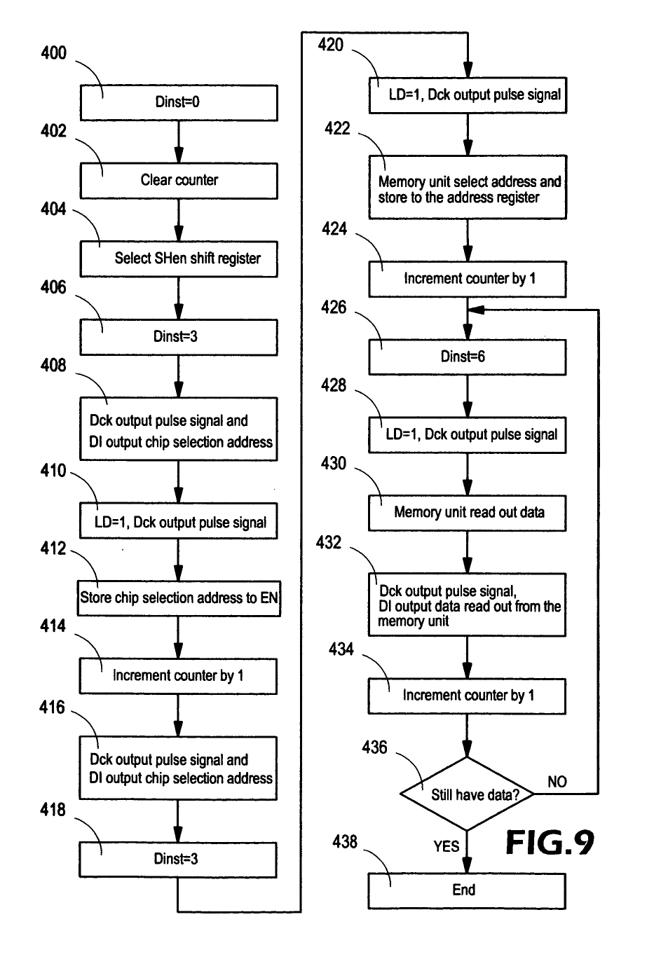

FIG. 9 shows the data reading procedure for the host 2 and the expansion device 3 through the communication interface 31 and the memory unit 33. In step 400, the Dinst signal is 0 for the host 2 or the previous-stage expansion device 3 in the initialization stage of the host 2. In step 402, the counter 319 in the expansion device 3 is reset. In step 404, the shift register 34 for converting the control enable signal SHen is selected. In step 406, the Dinst signal is changed to 3 when the host 2 ensures the selection of the shift register 34. In step 408, the pulse signal Dck outputs pulse signal and the data transmission line DI outputs chip selection address.

In step 410, the pulse signal Dck outputs pulse signal when the LD signal is 1. In step 412, the chip selection signal is stored in the register 35 for the enable level signal EN. In step 414, the counter 319 is incremented by 1. In step 416, the pulse signal Dck outputs pulse signal and the data transmission line DI outputs address selection signal for the memory unit 33. When the Dinst signal is 3 in step 418, the LD signal=1 and the pulse signal Dck outputs a pulse signal in step 420. In step 422, the address selection signal for the memory unit 33 is stored in the address register 36. In step 424, the counter 319 is incremented by 1. When the Dinst signal is 6 in step 426, the LD signal=1 and the pulse signal Dck outputs a pulse signal in step 428. The data stored in the memory unit 33 is read out in step 430. The pulse signal Dck outputs a pulse signal and the data read from the memory unit 33 is output from the data transmission line DI in step 432. In step 434, the counter 319 is incremented by 1. Step 436 judges whether the memory unit 33 still has data. The process is finished when no data is in memory unit 33 in step 438.

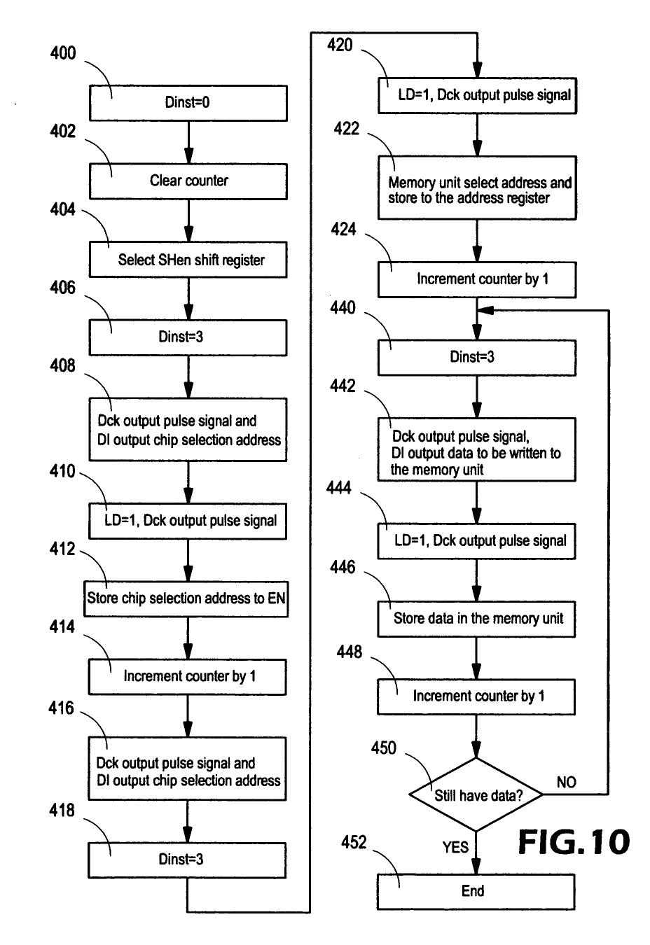

FIG. 10 shows the data writing procedure for the host 2 and the expansion device 3 through the communication interface 31 and the memory unit 33. Those signal and steps for the data writing procedure are similar to those shown in steps 400-424 except the data write control to the memory unit 33. In step 440, when the Dinst signal is 6, the pulse signal Dck outputs a pulse signal and the data transmission line DI outputs the data to be written to the memory unit 33 in step 442. Afterward, LD signal=1 and the pulse signal Dck outputs a pulse signal in step 444. The data is stored in the memory unit 33 in step 446 and the counter 319 is incremented by 1 in step 448. Step 450 judges whether the memory unit 33 still has data. The process is finished when no data is in memory unit 33 in step 452.

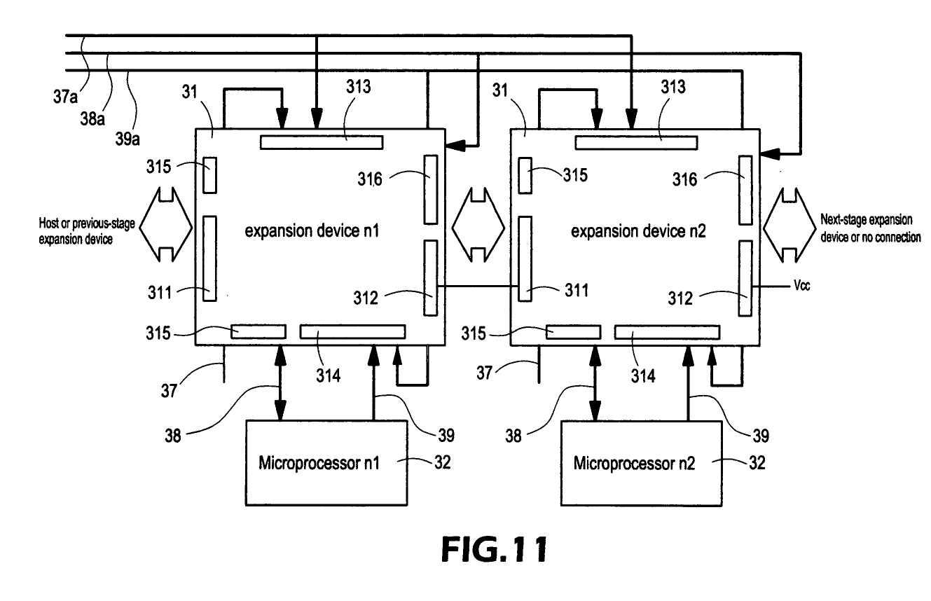

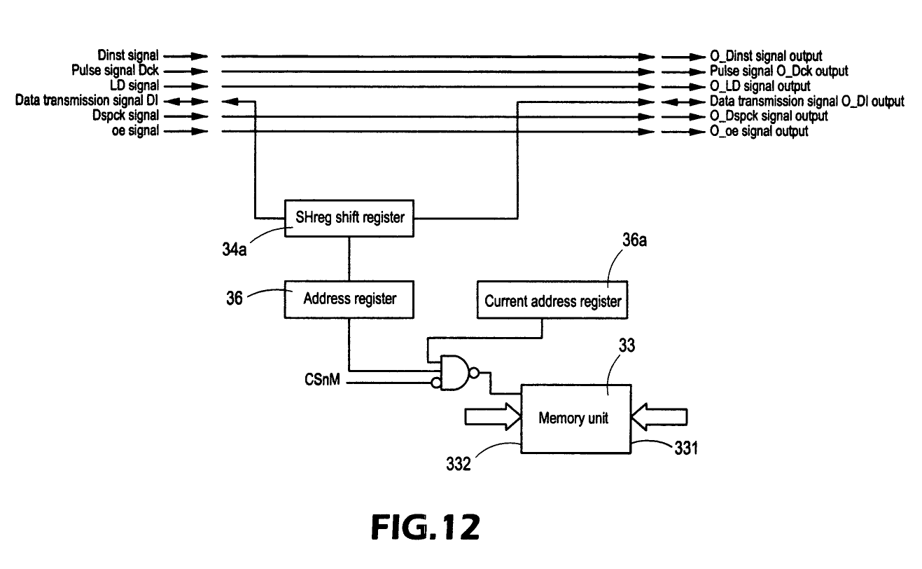

FIGS. 11 and 12 shows the diagrams for special parallel (not digital point) expansion mode (RAM reading mode). The expansion device 3 uses the communication interface 31 and the hardware mode setting connection module (InMode0˜5 & ODEM1˜3) 315 to set up the type, capacity and code of the expansion device. The expansion device 3 uses the previous-stage connection module 311 and the next-stage connection module 312 to connect the host 2 or the previous-stage expansion device 3 and the next-stage expansion device 3 to form a serial communication connection between the host 2 and the expansion devices 3 through address line 37a, data line 38a and addressing line 39a. The Pb10/AD2_{—}0˜Pb15/AD2_{—}5and Dr0/AD2_{—}6 Dr0/AD2_{—}7 connection end in the first setting connection module 313 and the Pa8/CS1n˜Pa15/RD2n connection end in the second setting connection module 314, and slave mode connection module (LED/DATA2_{—}0˜LED/DATA2_{—}7) 316 are used to connect to the second output end 332 of the memory unit 33, thus forming output setting for the host mode output.

The expansion device 3 performs a chip addressing procedure in power on and the host 2 performs an initialization step. The host 2 then reads signal from a judgment module D_inst0˜2or D_insto0˜2) to judge the type, and capacity of the expansion device and to ensure the normal connection and operation between the host 2 and the expansion device 3. When a code is sent from the host 2 or the previous-stage expansion device 3, the expansion device 3 receives code of the host 2 through the communication interface 31 or the previous-stage expansion device 3. When the judgment is to allow the expansion device 3 to connect between the memory unit 33 and the host 2, a bi-directional data exchange path is formed for data reading and writing. In other word, the memory unit 33 provides a data register and the host 2 uses the serial communication interface 21 to access the temporary data in the memory unit 33 and the expansion device 3.

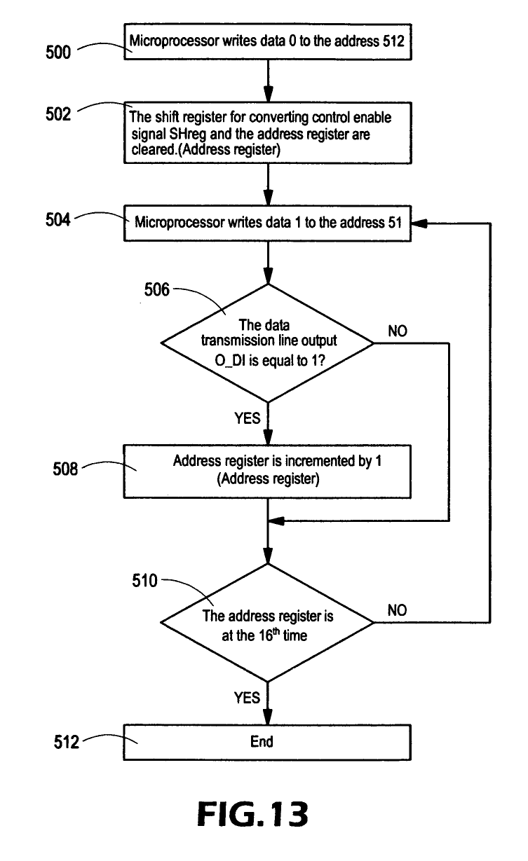

The chip addressing procedure needs to perform once when the expansion device 3 is powered on and the chip addressing procedure is shown in FIG. 13. In step 500, the microprocessor 32 writes data 0 to the address 512. In step 502, the shift register 34a for converting control enable signal SHreg and the address register 36 are cleared. In step 504, the microprocessor 32 writes data 1 to the address 512. Step 506 judges whether the data transmission line output O_DI is equal to 1. When the data transmission line output O_DI is equal to 1, the address register 36 is incremented by 1 in step 508. When the data transmission line output O_DI is not equal to 1, step 510 judges whether the address register 36 is at the 16^{th} time. When the address register 36 is at the 16^{th} time, the chip addressing procedure is ended at step 512, otherwise the procedure is back to step 504.

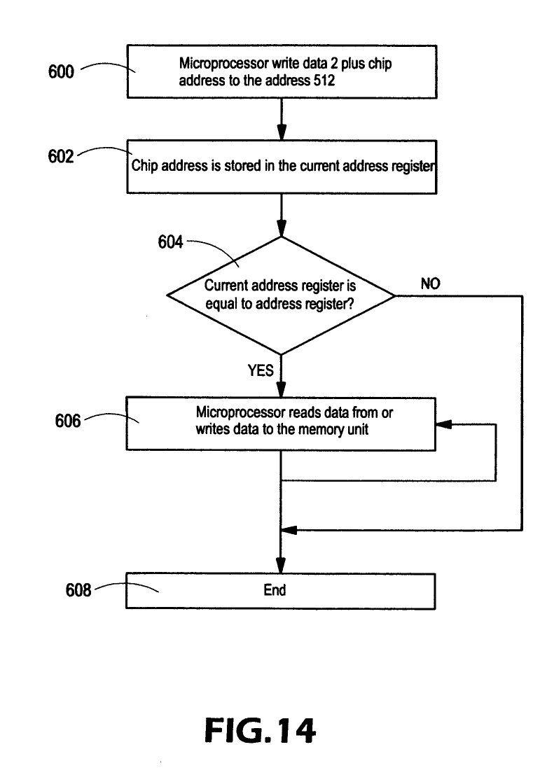

The expansion device 3 is connected to the host 2 or the previous-stage expansion device 3 and the next-stage expansion device 3 through the communication interface 31, and the data accessing operation thereof is shown in FIG. 14. In step 600, the microprocessor 32 writes data 2 plus chip address to the address 512. In step 602, the chip address is stored in the current address register. Step 604 judges whether the current address register 36a is equal to the address register 36. When the judgment is equal, the microprocessor 32 reads data from or writes data to the memory unit 32 in step 606. Afterward, the accessing procedure is ended in step 608. When the judgment is not equal, no data accessing is performed and the procedure is directly ended.

In the present invention, the multiple mode communication interface for expansion device and PLC host is implemented by integrated circuit. The multiple mode communication interface is already defined with different expansion device types and connection module of various function settings. The multiple mode communication interface is used with host for connect the host with various expansion devices. Therefore, the various expansion devices can be flexibly connected and the number of I/O expansion number can be set according to point numbers. The overhead in hardware communication and hardware design for I/O point expansion can be saved.

Moreover, at least memory unit is provided in the expansion device, and the memory unit is used with the communication interface to form register path for bi-directional data exchange. Therefore the host can be communicated with expansion device in special way such as parallel master-slave mode for non-digital expansion devices.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A multiple mode communication interface for expansion device and PLC host, comprising
a host comprising
a communication interface comprising an integrated circuit and a connection module with a plurality of function settings;
a microprocessor electrically connected to the communication interface;
at least one expansion device comprising:
a microprocessor;
a memory unit electrically connected to the microprocessor;
a communication interface comprising an integrated circuit and a connection module with a plurality of function settings;
wherein the communication interface of the expansion device is connected to the host or the next expansion device, the connection module in the communication interface of the expansion device sets I/O expansion pin to allow the host for connecting to the expansion device, the expansion device automatically allow or block the data from the host and access data stored in the memory unit according to a positioning value output from the host.

2. The multiple mode communication interface for expansion device and PLC host as in claim 1, wherein the interface of the host and the expansion device comprises address line, data line and addressing line in one of serial and parallel connection.

3. The multiple mode communication interface for expansion device and PLC host as in claim 1, wherein the integrated circuit of the host and the integrated circuit of the expansion device are the same integrated circuit and have the connection module in same design.

4. The multiple mode communication interface for expansion device and PLC host as in claim 1, wherein the communication interface of the expansion device comprising an integrated circuit, the integrated circuit comprising:
a previous-stage connection module electrically connected to the host or the previous-stage expansion device;
a next-stage connection module electrically connected to the next-stage expansion device;
a first setting connection module and a second setting connection module, which setting I/O point expansion and external connection and performing data read and output;
a hardware mode setting connection module for setting type of the expansion device such that the host can judge in initialization, the hardware mode setting connection module electrically connected to the host or the previous-stage expansion device to send a positioning value or a converted positioning value to next-stage expansion device, whereby the host determines connection status or accessing data through the memory unit by the positioning value;
a slave mode connection module electrically connected a light emitting element to output digital point status, or the expansion device accessing the data in the memory unit;
an input control circuit controlling the data reading of the first setting connection module and the second setting connection module;
an output control circuit controlling the data output of the first setting connection module and the second setting connection module.

5. The multiple mode communication interface for expansion device and PLC host as in claim 4, wherein the communication interface comprises a convert control signal electrically connected to the host, an adjacent expansion device and power signal Vcc in single wire way.

6. The multiple mode communication interface for expansion device and PLC host as in claim 4, further comprising a counter electrically connected to the hardware mode setting connection module for generating a counting signal.

7. The multiple mode communication interface for expansion device and PLC host as in claim 4, wherein the previous-stage connection module further comprises at least judgment module for connecting to the expansion devices of various types and identifying the type of the expansion device through signal sent from the expansion device.

8. The multiple mode communication interface for expansion device and PLC host as in claim 4, wherein the next-stage connection module further comprises at least judgment module for connecting to the expansion devices of various types and identifying the type of the expansion device through signal sent from the expansion device.

9. The multiple mode communication interface for expansion device and PLC host as in claim 4, wherein the input control circuit further comprises an I/O channel switch control (PISO) and a latch, the latch being electrically connected to a display control to control the light emitting element for showing expansion point status, the I/O channel switch control (PISO) and the latch being electrically connected to the previous-stage connection module for receiving signals from the previous-stage connection module and receiving data trough the first setting connection module and the second setting connection module.

10. The multiple mode communication interface for expansion device and PLC host as in claim 9, wherein the I/O channel switch control (PISO) is electrically connected to pulse signal input end (Dck) and data transmission end of previous-stage connection module through switch elements, and electrically connected to a data input end through another switch element, wherein two serially-connected switch elements perform switching between the data input end and the data transmission end DI, the latch is electrically connected to LD signal of previous-stage connection module through switch elements to receive control signal from the previous-stage connection module.

11. The multiple mode communication interface for expansion device and PLC host as in claim 4, wherein the output control circuit further comprises a database manage (SIPO) and a latch, the latch being electrically connected to a display control to control the light emitting element for showing expansion point status, the database manage (SIPO) and the latch being electrically connected to the previous-stage connection module for receiving signals from the previous-stage connection module and outputting data trough the first setting connection module and the second setting connection module.

12. The multiple mode communication interface for expansion device and PLC host as in claim 11, wherein the database manage (SIPO) is electrically connected to pulse signal input end (Dck) and data transmission end of previous-stage connection module through switch elements, and electrically connected to a data input end through another switch element, wherein two serially-connected switch elements perform switching between the data input end and the data transmission end DI, the latch is electrically connected to LD signal of previous-stage connection module through switch elements to receive control signal from the previous-stage connection module.

13. The multiple mode communication interface for expansion device and PLC host as in claim 1, wherein the memory unit further comprises a first output end and a second output end.

14. A method for multiple mode communication interfacing for expansion device and PLC host, comprising steps of:
setting expansion type, capacity and code for expansion device through a hardware mode setting connection module of a communication interface;
forming a serial connection between a host and expansion devices by connecting the host and the previous-stage expansion device and next--stage expansion device through a previous-stage connection module and a next-stage connection module in the communication interface;
setting I/O expansion number and pins through a first setting connection module and a second setting connection module;
the host performing initialization step to judge the expansion type and capacity of the expansion device connected to the host and a normal connection with the expansion device by reading a signal from a judgment module;
the host and an adjacent expansion device converting a code for sending to the expansion device;
the expansion device automatically allowing or blocking the data sent from the host.

15. A method for multiple mode communication interfacing for expansion device and PLC host, comprising steps of:
setting expansion type, capacity and code for expansion device through a hardware mode setting connection module of a communication interface;
forming a serial connection with address line, data line and addressing line between a host and expansion devices by connecting the host and the previous-stage expansion device and next-stage expansion device through a previous-stage connection module and a next-stage connection module in the communication interface;
forming a host mode output setting by connecting a first setting connection module and a second setting connection module of the communication interface to an output end of a memory unit;
the host performing initialization step to judge the expansion type and capacity of the expansion device connected to the host and a normal connection with the expansion device by reading a signal from a judgment module;
the host and an adjacent expansion device converting a code for sending to the expansion device;
the expansion device automatically allowing or blocking the data sent from the host;
the expansion device judging data accessing with the memory unit with reference to code and forming register path mode for bi-directional data exchange; and
the host accessing temporary data in the memory unit through serial communication interface, and the expansion device accessing temporary data in the memory unit through host mode.

16. The method as in claim 15, wherein the expansion device is a non-digital point expansion device.

17. A method for multiple mode communication interfacing for expansion device and PLC host, comprising steps of:
setting expansion type, capacity and code for expansion device through a hardware mode setting connection module of a communication interface;
forming a serial connection with address line, data line and addressing line between a host and expansion devices by connecting the host and the previous-stage expansion device and next-stage expansion device through a previous-stage connection module and a next-stage connection module in the communication interface;
forming a host mode output setting and a slave mode output setting by connecting a first setting connection module and a second setting connection module of the communication interface to two output ends of a memory unit;
the expansion device performing a chip addressing step in power on;
the host performing initialization step to judge the expansion type and capacity of the expansion device connected to the host and a normal connection with the expansion device by reading a signal from a judgment module;
the host and an adjacent expansion device converting a code for sending to the device;
the expansion device automatically allowing or blocking the data sent from the host;
the expansion device judging data accessing with the memory unit with reference to code and forming register path mode for bi-directional data exchange; and
the host accessing temporary data in the memory unit through serial communication interface, and the expansion device accessing temporary data in the memory unit through host mode.
